(19) United States
(12) Patent Application Publication
(10) Pub. No.: US 2026/0064934 A1
(43) Pub. Date: Mar. 5, 2026

(54) METHOD AND APPARATUS, DEVICE, MEDIUM AND PROGRAM PRODUCT FOR ALIGNING TEXTS

(71) Applicant: Beijing Zitiao Network Technology Co., Ltd., Beijing (CN)

(72) Inventor: Xinyue WANG, Beijing (CN)

(21) Appl. No.: 19/315,348

(22) Filed: Aug. 29, 2025

(30) Foreign Application Priority Data
Aug. 30, 2024 (WO) PCT/CN2024/115736

(51) Int. Cl. G06F 40/103; G06F 3/0485; G06F 40/166

(52) U.S. Cl. CPC G06F 40/103; G06F 3/0485; G06F 40/166

(57) ABSTRACT

Embodiments of the present disclosure relate to a method and apparatus for aligning texts, a device, a medium and a program product. The method comprises displaying an original text and a modified text of the original text. The method also comprises receiving hovering of a cursor over a first line in one text of the original text or the modified text. The method also includes highlighting the first line and a second line in the other text of the original text or the modified text corresponding to the first line based on hovering of the cursor over the first line. The method further includes in response to receiving an operation for clicking associated with the hovering cursor, aligning the first line with the second line to implement text alignment.

### CROSS-REFERENCE TO RELATED APPLICATION(S)

This application claims priority to PCT Application No. PCT/CN2024/115736 filed Aug. 30, 2024, the disclosure of which is incorporated herein by reference in its entirety.

### FIELD

Embodiments of the present disclosure generally relate to the field of text processing, and more specifically; to method and apparatus, device, medium and program product for aligning texts.

### BACKGROUND

At present, text viewing has become an indispensable part of people's daily life and work life. Especially at work, when it is required to modify a document multiple times, it is inevitable to view the previous version or multiple versions of the document to be modified, so as to determine the difference between the current version and the previous version, i.e., additions or deletions.

With the rapid development of text processing technology; in case of viewing different versions of a text, different text viewing software and/or text modification software can be used to obtain different versions of the document, so that the users can view different versions of the document on the same interface at the same time, modify them according to their needs, and mark the modified parts in a pre-set manner as reminders. In addition, in order to meet the development needs of text processing technology, various types of text viewing software and/or text modification software provide an increasing number of applications and functions in text viewing.

### SUMMARY

Embodiments of the present disclosure provide a method and apparatus, a device, a medium and a program product for aligning texts.

In accordance with a first aspect of the present disclosure, there is provided a method for aligning texts. The method comprises displaying an original text and a modified text of the original text. The method also comprises receiving hovering of a cursor over a first line in one text of the original text or the modified text. The method also includes highlighting the first line and a second line in the other text of the original text or the modified text corresponding to the first line based on hovering of the cursor over the first line. The method further includes in response to receiving an operation for clicking associated with the hovering cursor, aligning the first line with the second line to implement text alignment.

In accordance with a second aspect of the present disclosure, there is provided an apparatus for aligning texts. The apparatus comprises an original text and modified text display module configured to display an original text and a modified text for the original text: a cursor hovering receiving module configured to receive hovering of a cursor over a first line in one text of the original text or the modified text: a highlight display module configured to highlight the first line and a second line in the other text of the original text or the modified corresponding to the first line text based on hovering of the cursor over the first line; and a text alignment module configured to, in response to receiving an operation for clicking associated with the hovering cursor, align the first line with the second line to implement text alignment.

In accordance with a third aspect of the present disclosure, there is provided an electronic device, comprising at least one processor; and a memory for storing at least one program, the at least one program, when executed by the at least one processor, causing the at least one processor to implement the method according to the first aspect of the present disclosure.

In accordance with a fourth aspect of the present disclosure, there is provided a computer-readable storage medium stored thereon with computer programs, the computer programs, when executed by a processor, implementing the method according to the first aspect of the present disclosure.

In accordance with a fifth aspect of the present disclosure, there is provided a computer program product. The computer program product includes computer programs, which computer programs, when executed by a processor, causing the processor to perform the method according to the first aspect of the present disclosure.

It should be appreciated that the contents described in this Summary are not intended to identify key or essential features of the embodiments of the present disclosure, or limit the scope of the present disclosure. Other features of the present disclosure will be understood more easily through the following description.

### BRIEF DESCRIPTION OF THE DRAWINGS

Through the following detailed description of the example embodiments of the present disclosure with reference to the accompanying drawings, the above and other objectives, features, and advantages of the present disclosure will become more apparent. In the example embodiments of the present disclosure, the same reference sign usually indicates the same component.

FIG. 1 illustrates a schematic diagram of an example environment in which the device and/or method according to some embodiments of the present disclosure may be implemented;

FIG. 2 illustrates a schematic diagram of an example method for aligning texts according to some embodiments of the present disclosure:

FIG. 3 illustrates a schematic diagram of an example for aligning texts in accordance with some embodiments of the present disclosure:

FIG. 4 illustrates a schematic diagram of another example for aligning texts according to some embodiments of the present disclosure:

FIG. 5 illustrates a schematic diagram of a further example for aligning texts according to some embodiments of the present disclosure:

FIG. 6 illustrates a schematic diagram of an example for synchronous scroll and asynchronous scroll of the text according to some embodiments of the present disclosure:

FIG. 7 illustrates a schematic diagram of an example of partitioning of the navigation bar of the text according to some embodiments of the present disclosure:

FIG. 8 illustrates a schematic diagram of an example for displaying the number of modifications on the navigation bar sub-region of the text according to some embodiments of the present disclosure:

FIG. 9 illustrates a schematic diagram of an example in which modification marks in the sub-region of the navigation bar are enlarged according to some embodiments of the present disclosure:

FIG. 10 illustrates a schematic diagram of an example for automatically jumping to the modification position of text alignment according to some embodiments of the present disclosure:

FIG. 11 illustrates a schematic block diagram of an apparatus for aligning texts according to some embodiments of the present disclosure:

FIG. 12 illustrates a schematic block diagram of an example device adapted to implement a plurality of embodiments of the present disclosure.

In each drawing, same or corresponding reference sign indicates the same or corresponding component.

### DETAILED DESCRIPTION OF EMBODIMENTS

It is to be understood that data involved in the technical solutions of the present disclosure, including but not limited to data per se, and acquisition or use of the data, should follow requirements of corresponding laws, regulations and rules. In response to receiving an active request from the users, a prompt information is sent to the users to clearly inform them that the operation requested to be executed needs to obtain and use their personal information. Accordingly: the users may voluntarily select, in accordance with the prompt information, whether to provide their personal information to software or hardware that performs operations of the technical solution, such as electronic device, application program, server or storage medium.

Embodiments of the present disclosure will be described below in more details with reference to the drawings. Although the drawings illustrate some embodiments of the present disclosure, it should be appreciated that the present disclosure can be implemented in various manners and should not be limited to the embodiments explained herein. On the contrary: the embodiments are provided for a more thorough and complete understanding of the present disclosure. It is to be understood that the drawings and the embodiments of the present disclosure are provided merely for the exemplary purpose, rather than restricting the protection scope of the present disclosure.

In the description of the embodiments of the present disclosure, the term “includes” and its variants are to be read as open-ended terms that mean “includes, but is not limited to.” The term “based on” is to be read as “based at least in part on.” The term “one embodiment” or “this embodiment” is to be read as “at least one example embodiment.” The terms “first”. “second” and so on can refer to same or different objects. The following text also may include other explicit and implicit definitions.

There are still many problems to be addressed during text alignment. For example, in traditional solutions, when viewing previous version and current version of a document, the users usually use a text viewing software and/or a text modification software to open the documents and separately display the previous version of the document and the current version of the document. In this way, the users may view the previous version of the document and the current version of the document simultaneously on a same display interface.

In traditional solutions, usually when the users are viewing a plurality of documents for comparison, they need to scroll through a single document separately and then scroll through a further document, so that the contents in the previous version of the document and in the current version of the document are displayed at the approximately same position to facilitate comparison. Besides, in order to align the same contents in the two texts, the existing text viewing software and/or text modification software would use empty fields as placcholders at the locations where there are no texts. This, however, affects the overall aesthetics of the aligned texts and the users' memory of the entire text and wastes the storage resources. Moreover, the previous version of the text and the current version of the text could not be automatically aligned and the users need to manually scroll the documents to the same content, which is labor-consuming and time-costing and also lowers the efficiency of the text alignment.

To at least solve the above and other potential problems, embodiments of the present disclosure provide a method for aligning texts. In this method, an original text and a modified text for the original text may be first displayed at a computing device. For example, the original text and the modified text may be displayed separately in a left column and a right column with a separation gap in between. Then, the computing device receives hovering of a cursor over a first line in one of the original text and the modified text. The computing device highlights the first line and a second line in the other of the original text and the modified text corresponding to the first line based on the hovering of the cursor over the first line. In the end, after receiving an operation for clicking associated with the hovering cursor, the computing device aligns the first line with the second line to implement text alignment. Through this method, the users may operate in any of the original text and the modified text when viewing the texts to implement text alignment. The text viewing efficiency is thus improved and the user experience is enhanced. Further improvements may also be made to control whether the two texts are scrolled synchronously, and the navigation bars may also be intelligently divided to highlight additions and deletions.

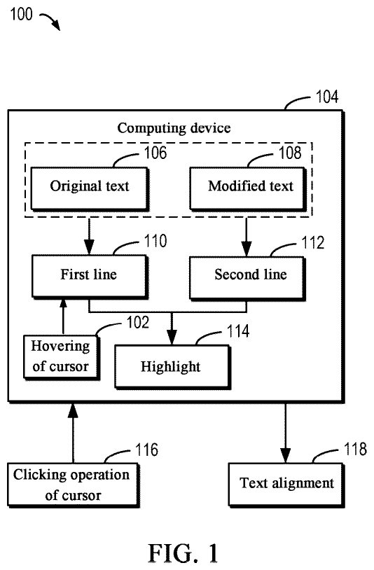

Embodiments of the present disclosure are to be described in details below with reference to the drawings, wherein FIG. 1 illustrates an example environment in which the device and/or method of the embodiments of the present disclosure may be implemented. In an environment 100, the computing device 104 first displays an original text 106 and a modified text 108 of the original text 106. For example, the original text 106 and the modified text 108 may be displayed separately in a left column and a right column with a separation gap in between. Then, the computing device 104 receives hovering 102 of a cursor over a first line in one of the original text 106 and the modified text 108. After receiving the hovering 102 of the cursor, the computing device 104 highlights 114 the first line 110 and a second line 112 corresponding to the first line in the other of the original text 106 and the modified text 108 in accordance with the hovering of the cursor over the first line. In the end, after receiving an operation 116 for clicking the cursor, the computing device 104 aligns the first line 110 with the second line 112 to implement text alignment 118.

Examples of the computing device 104 include, but not limited to, personal computer, server computer, handheld or laptop device, mobile device (such as mobile phone. Portable Digital Assistant (PDA), media player etc.), multi-processor system, consumer electronics, minicomputer, main frame computer and a distributed computing environment including any of the above systems or devices etc.

As shown in FIG. 1, the computing device 104 first displays the original text 106 and the modified text 108 of the original text 106. In one example, the original text 106 and the modified text 108 of the original text 106 are obtained directly from a local storage device or received from other computing devices. In another example, the original text 106 and the modified text 108 of the original text 106 are obtained by the computing device 104 from the server. For example, the computing device 104 may obtain the already stored original text 106 and the modified text 108 of the original text 106 directly from the local server. The computing device 104 also may obtain from a remote server the original text 106 and the modified text 108 of the original text 106 already stored therein via Internet.

In such case, the original text 106 and the modified text 108 of the original text 106 correspond to each other, and the original text 106 and the modified text 108 should at least contain an overlapping content. Additionally, when the original text 106 and the modified text 108 are completely different, the computing device 104 gives a hint on its display screen. For example, the computing device displays on the screen “the original text has been completely modified and there is no consistency between the currently modified text and the original text”.

Afterwards, the computing device 104 may receive hovering 102 of the cursor over the first line 110 in one of the original text 106 and the modified text 108, wherein a duration of the hovering 102 of the cursor is recorded by the computing device 104. In one example, the first line 110 may be any line in any segment of the original text 106. In another example, the first line 110 may be any line in any segment of the modified text 108. The above examples are provided merely for describing the present disclosure, rather than restricting it.

Then, subsequent to receiving the hovering 102 of the cursor, the computing device 104 highlights 114 the first line 110 and the second line 112 corresponding to the first line 110 in the other of the original text 106 and the modified text 108 based on the hovering of the cursor over the first line 110. This highlight 114 may be any striking hint. For example, the highlight 114 may be in any colors or in any forms of line box: the first line 110 and the second line 112 may be highlighted in boxes. In addition, the first line 110 may be from the modified text 108 and the second line may be from the original text 106. The above examples are provided merely for describing the present disclosure, rather than restricting it.

In some embodiments, the computing device 104 may highlight the entire first line 110 and the second line 112. In some other embodiments, the computing device 104 may highlight text portion of the first line 110 and the second line 112, not the blank portion.

In some embodiments, the computing device 104 would initiate the text alignment prompt function only when it detects that the cursor is within the text range.

In the end, after receiving the operation 116 of clicking the cursor, the computing device 104 aligns the first line 110 with the second line 112 to implement text alignment 118. In some embodiments, upon receiving the operation 116 of clicking the cursor, the computing device 104 may scroll a text corresponding to the second line 112, to align the original text 106 with the modified text 108 to implement text alignment. In some other embodiments, after receiving the operation 116 of clicking the cursor, the computing device 104 may scroll the original text 106 corresponding to the first line 110 to align the original text 106 with the modified text 108 to implement text alignment.

Through this method, while viewing the texts, the users may operate in either of the original text and the modified text to carry out the text alignment operation. Therefore, the efficiency for text viewing is improved and the user experience is enhanced.

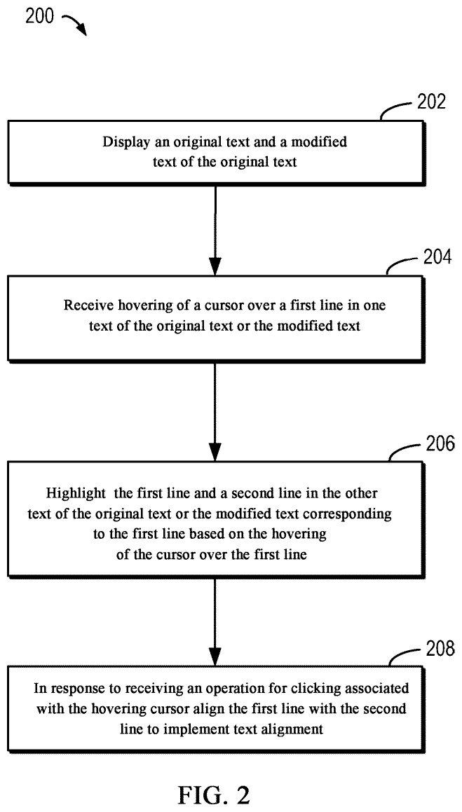

The schematic diagram of an example environment in which the device and/or method according to some embodiments of the present disclosure may be implemented has been described above with reference to FIG. 1. Next, a schematic diagram of an example method 200 for aligning texts according to some embodiments of the present disclosure is to be depicted below with reference to FIG. 2. The method may be applied into the example environment in FIG. 1 or in any suitable environments and may be executed by the computing device 104 or any suitable computing devices.

As shown in FIG. 2, in the example method 200, the computing device 104 displays the original text 106 and the modified text 108 of the original text 106 at block 202. In one example, the original text is an initial unmodified version, and the modified text is an adjusted version. In a further example, the original text is a previously modified version and the modified text is a version resulted from further modification on the previously modified version. The above examples are provided merely for describing the present disclosure, rather than restricting it.

In some embodiments, the original text 106 and the modified text 108 are displayed separately in the left column and the right column with a separation gap in between. In one example, the original text 106 is displayed in the left column and the modified text 108 is displayed in the right column. In another example, the modified text 108 is displayed the left column while the original text 106 is in the right column.

In some embodiments, the computing device 104 also may display on a display screen navigation bars corresponding to the original text 106 and the modified text 108. Besides, the navigation bars may be displayed above, below, to the left or to the right of the original text 106 and the modified text 108.

In some embodiments, the navigation bars of the original text 106 and the modified text 108 may both be positioned above the corresponding texts. In some further embodiments, the navigation bar of the original text 106 and the navigation bar of the modified text 108 may be separately positioned above the original text 106 and below the modified text 108. The above examples are provided merely for describing the present disclosure, rather than restricting it.

In some embodiments, the computing device 104 also may receive an operation for dragging the cursor to change the position of the navigation bar in the original text 106 or the modified text 108. For example, the computing device 104 receives an operation for dragging the cursor to drag the navigation bar above the original text 106 to the left of the original text 106.

In some embodiments, the computing device 104 also may determine a deleted portion in the original text 106 and an added portion in the modified text 108. The deleted portion and the added portion, after being determined, are highlighted.

In some embodiments, the highlight may be in any colors, and the entire line in which the added or deleted portion is located may be highlighted. In some other embodiments, only the text portion of the line in which the added or deleted portion is located is highlighted.

In some embodiments, the original text 106 and the modified text 108 may also be scrolled in the computing device 104. In one example, the computing device 104 also may display on the corresponding display screen two scroll controls for the original text 106 and the modified text 108, wherein one control is used for scrolling the original text 106 and the modified text 108 simultaneously and the other control is provided for scrolling the original text 106 and the modified text 108 separately. When one of the two controls is selected, a corresponding function is performed. In another example, the computing device 104 also may display on the corresponding display screen scroll mode controls for the original text 106 and the modified text 108. The scroll mode controls include two modes. i.e., synchronous scroll mode and non-synchronous scroll mode, where the non-synchronous scroll mode also may be referred to as asynchronous scroll mode.

In some embodiments, in case that the computing device 104 receives an operation for clicking associated with the hovering cursor to select the synchronous scroll control or the synchronous scroll mode, the modified text 108 is scrolled synchronously upon receipt of the first scroll operation for the original text 106. Additionally, if the control for synchronous scroll is selected or under the synchronous scroll mode, the original text 106 is scrolled synchronously upon receipt of the first scroll operation for the modified text 108.

In some embodiments, in case that the computing device 104 receives an operation for clicking associated with the hovering cursor to select a control for separate scroll or the asynchronous scroll mode, only the original text 106 is scrolled when a second scroll operation for the original text 106 is received. The scroll operation is not performed on the modified text 108. Additionally, when the second scroll operation for the modified text 108 is received, only the modified text 108 is scrolled and the scroll operation is not executed on the original text 106.

Then, at block 204, the computing device 104 receives the hovering 102 of the cursor over the first line 110 in one of the original text 106 and the modified text 108, wherein the duration of the hovering 102 of the cursor is recorded by the computing device 104. In one example, the first line 110 may be any line in any segment of the original text 106. In another example, the first line 110 may be any line in any segment of the modified text 108. The above examples are provided merely for describing the present disclosure, rather than restricting it.

In some embodiments, the computing device 104 receives the hovering of the cursor over the first line 110, wherein the cursor may hover over any position in the first line. In some further embodiments, when the cursor hovers over the blank in the first line 110, the computing device 104 does not receive the hovering of the cursor. It is only when the cursor hovers over the text portion of the first line 110, the computing device 104 will receive the hovering 102 of the cursor.

Next, at block 206, the computing device 104 highlights 114 the first line 110 and the second line 112 corresponding to the first line in the other of the original text 106 and the modified text 108 based on the hovering of the cursor over the first line 110. This highlight 114 may be any striking hint. For example, the highlight 114 may be in any colors or in any forms of line box; the first line 110 and the second line 112 may be highlighted in boxes. In addition, the first line 110 may be from the modified text 108 and the second line may be from the original text 106; or the first line is from the original text 106 and the second line is from the modified text 108. The above examples are provided merely for describing the present disclosure, rather than restricting it.

In some embodiments, when it is recorded by the computing device 104 that the duration of the hovering of the cursor over the first line 110 reaches or exceeds a predetermined duration, e.g., one second, the computing device 104 will determine the second line 112 corresponding to the first line 110 in the modified text 108 and then highlight the first line 110 and the second line 112.

In some embodiments, after the first line 110 and the second line 112 are highlighted, the computing device 104 will also form a connecting line between the first line 110 and the second line 112, and the connecting line runs through the gap between the original text 106 and the modified text 108. In one example, the connecting line may be a solid line. In another example, the connecting line may be a dotted line. In a further example, the connecting may be either of the straight line and the curved line.

In the end, at block 208, in response to receiving an operation 116 for clicking the cursor, the computing device 104 aligns the first line 110 with the second line 112 to implement text alignment 118.

In some embodiments, when receiving an operation for clicking the first line 110 of the original text 106, the computing device 104 scrolls the modified text, such that the second line 112 and the first line are at the same horizontal position to implement text alignment. In addition, at this moment, the connecting line between the first line 110 and the second line 112 should also be horizontal and vertically cross the gap between the original text 106 and the modified text 108.

Through this method, while viewing the texts, the users may operate in any of the original text and the modified text to perform the text alignment operation. Besides, it is controlled whether the two texts are synchronously scrolled. The navigation bars are also intelligently divided to highlight additions and deletions. Therefore, the efficiency for text viewing is improved and the user experience is enhanced.

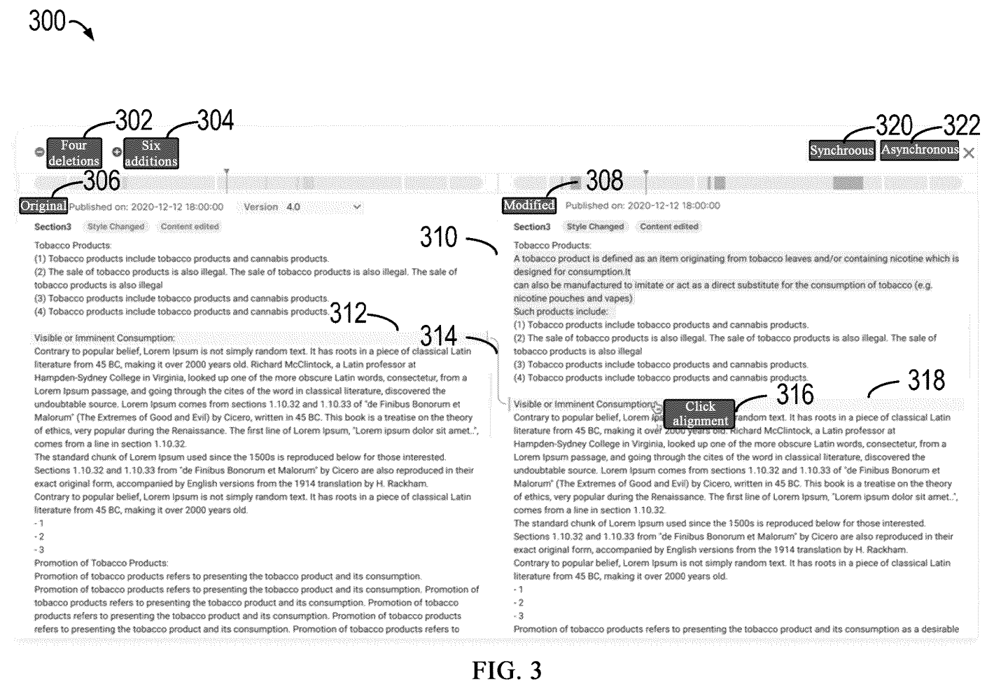

The schematic diagram of the example method 200 for aligning texts in accordance with some embodiments of the present disclosure has been described above with reference to FIG. 2. Next, a schematic diagram of an embodiment for aligning texts in accordance with some embodiments of the present disclosure is to be depicted in conjunction with FIG. 3.

In the example 300, the display screen of the computing device 104 includes a prompt information box 302 for deletions, a prompt information block 304 for additions, a synchronous scroll mode control 320, an asynchronous scroll mode control 322, an original text information box 306, a modified text information box 308, a gap 310, a highlight 318 for first line, a connecting line 314, a prompt information box 316 for an alignment operation and a highlight 312 for second line.

It is displayed in box 302 that there are four deletions in the current original text and it is displayed in box 304 that there are six additions in the current modified text. The display part may automatically change in accordance with modifications and variations of the original text and the modified text. For example, if a further deletion is made in the original text. “four deletions” in box 304 may change to “five deletions”.

When receiving the hovering of the cursor over the first line, the computing device 104 will highlight 318 the entire first line. i.e., the entire first line is highlighted. At this time, a connecting line 314 appears. The first line is connected with the second line while the second line is highlighted 312. This highlight 312 is performed in the same way as the highlight 318.

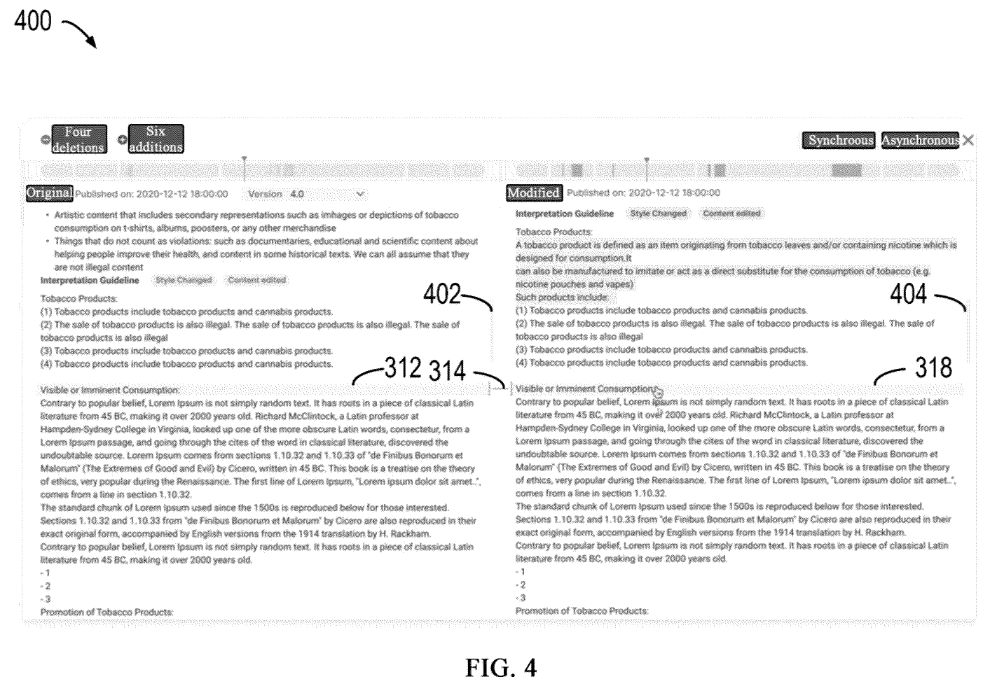

In one example, when the cursor hovers over the first line, the prompt information box 316 saying “click to align” is displayed. In another example, when receiving that the hovering of the cursor over the second line reaches or exceeds a predetermined duration, such as one second, the computing device 104 displays the prompt information box 316 stating “click to align”. In addition, the content of the prompt information may be set voluntarily in view of the needs of the users. The following operations are to be described below with reference to FIG. 4.

In the example 400, with reference to the previous example 300, the computing device 140 may display the prompt information box 316 stating “click to align”. Then, the computing device 140 performs the operation for text alignment after receiving the operation for clicking associated with the hovering cursor to automatically scroll the second line in the original text to the same horizontal position as the first line in the modified text.

In some embodiments, a scroll bar 402 corresponding to the original text is also at the same horizontal position as a scroll bar 404 corresponding to the modified text. In addition, when the lengths of the original text and the modified text are inconsistent, the scroll bars 402 and 404 also have different lengths. In such case, the center of the scroll bar 402 is at the same horizontal position as the center of the scroll bar 404.

In some embodiments, when the text alignment operation is completed, the computing device sets the position of the first line and the second line at the first line of the text. In some other embodiments, after the text alignment operation is completed, the computing device sets the position of the first line and the second line at the middle of the text.

In some embodiments, after completing the text alignment operation, the computing device changes the connecting line 314 into a horizontal connecting line. Additionally: after the text alignment operation is completed, the computing device may delete the connecting line 314.

In some embodiments, after completing the text alignment operation, the computing device continues to maintain the highlight 312 and the highlight 318 for a predetermined duration. For instance, the computing device continues to maintain for 1.5 seconds to facilitate the users to confirm the text.

While viewing the texts, the users may operate in any of the original text and the modified text to execute the text alignment operation and highlight the number of additions and deletions. The above operation improves the efficiency for text viewing and enhances the user experience.

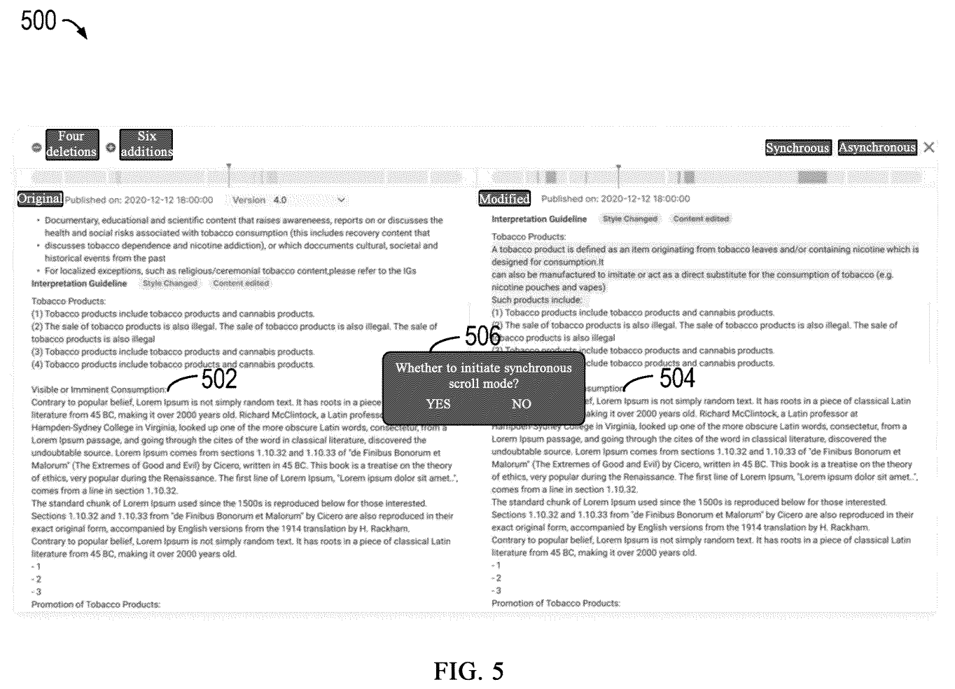

The schematic diagram of an embodiment for aligning texts according to some embodiments of the present disclosure has been described above with reference to FIG. 4. Next, a schematic diagram of another embodiment for aligning texts according to some embodiments of the present disclosure is to be depicted below with reference to FIG. 5.

In the example 500, with reference to the above examples 300 and 400, after completing the text alignment operation, the computing device continues to maintain the highlight 312 and the highlight 318 for a predetermined duration. For instance, the computing device continues to maintain for 1.5 seconds to facilitate the users to confirm the text.

In some embodiments, the highlight of the first line 502 and the highlight of the second line may disappear after a predetermined duration. In addition, a pop-up window 506 saying “whether to initiate synchronous scroll mode?” may also appear in the computing device 104.

In some embodiments, after the operation for clicking associated with the hovering cursor to choose “YES”, the computing device directly changes from the scroll mode into synchronous scroll mode. Additionally: when one of the original text and the modified text scrolls, the other text would scroll synchronously.

In some embodiments, after the operation for clicking associated with the hovering cursor to choose “NO”, the computing device directly changes to asynchronous scroll mode from the scroll mode. Additionally, when one of the original text and the modified text scrolls, the other text remains at the current position and does not scroll.

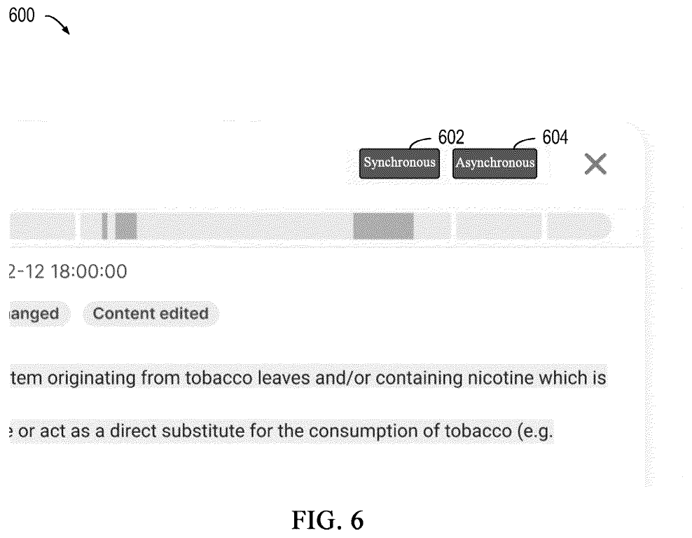

The schematic diagram of another embodiment for aligning texts according to some embodiments of the present disclosure has been described above with reference to FIG. 5. Next, a schematic diagram of an embodiment for synchronous scroll and asynchronous scroll of the text according to some embodiments of the present disclosure is to be depicted below with reference to FIG. 6.

In the example 600, there are a synchronous scroll control 602 and an asynchronous scroll control 604. With reference to the above examples 300, 400 and 500, after the text alignment operation is completed, the computing device determines the current mode to be the synchronous scroll mode when the users click the synchronous scroll control 602. In case that any of the original text and the modified text is scrolled, the other of the two texts is also scrolled synchronously.

After the users click the asynchronous scroll control 604, the computing device determines the current mode to be the asynchronous scroll mode. When any of the original text and the modified text is scrolled, the other text remains at the current position and does not scroll.

In some embodiments, the computing device will store the scroll mode of the previous text view, and continue to use the scroll mode of the previous text view by default at the current text view. In one example, the scroll mode of the previous text view is synchronous scroll mode and the current text view continues to use the synchronous scroll mode. Additionally, the users may voluntarily configure whether to continue to use the previous scroll mode in accordance with their own habits or needs.

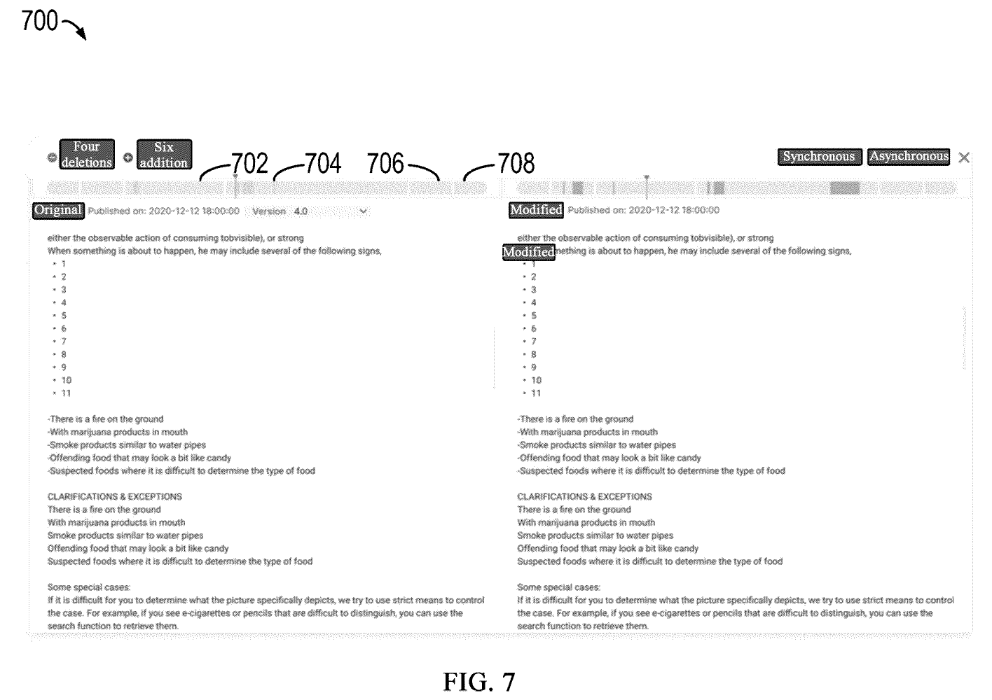

Further, in traditional text navigations, usually there is no partitioning within the scroll navigation. In such case, modification marks are too densely distributed in the navigation bar, making it difficult for users to accurately locate the target text. Without partitioning, the users cannot clearly determine in which part of the document the modified content appears (for example, the introduction part, the main part of the document, etc.). To further address the above issue, the present disclosure further adjusts the navigation bars. Next, a schematic diagram of an embodiment for partitioning of the navigation bar of the text according to some embodiments of the present disclosure is to be described below with reference to FIG. 7.

In the example 700, the original text and the modified text are consistent in overall structure, chapters and paragraphs. The navigation bar of the original text consists of a plurality of sub-regions, including sub-region 702, sub-region 704, sub-region 706 and sub-region 708. The navigation bar of the modified text is also comprised of a plurality of sub-regions. The number of sub-region in the navigation bars of the original text and the modified text corresponds to the number of paragraphs in the original text and the modified text. Alternatively, the original text and the modified text are inconsistent in overall structure. For example, they have different numbers of paragraphs. In such case, the number of sub-region in the navigation bars of the original text and the modified text also differs. In addition, the length of the sub-region in the navigation bar corresponds to the length of the paragraph in the text. The sub-regions corresponding to long paragraphs have a long length while the sub-regions corresponding to short paragraphs have a short length.

In some embodiments, the navigation bar may be positioned above, below, to the left or to the right of the original text or the modified text. In one example, the navigation bar of the original text is above the original text and the navigation bar of the modified text is below the modified text.

In some embodiments, the computing device may receive an operation for dragging the cursor to drag the navigation bar. For example, the navigation bar may be dragged from the above to the below, the left or the right.

In some embodiments, the computing device also may receive an operation for double clicking the cursor or triple clicking the cursor to hide the navigation bar. In one example, the navigation bar of the original text or the modified text may be hidden separately. In another example, the navigation bars of the original text and the modified text may be hidden synchronously. The above examples are provided merely for describing the present disclosure, rather than restricting it.

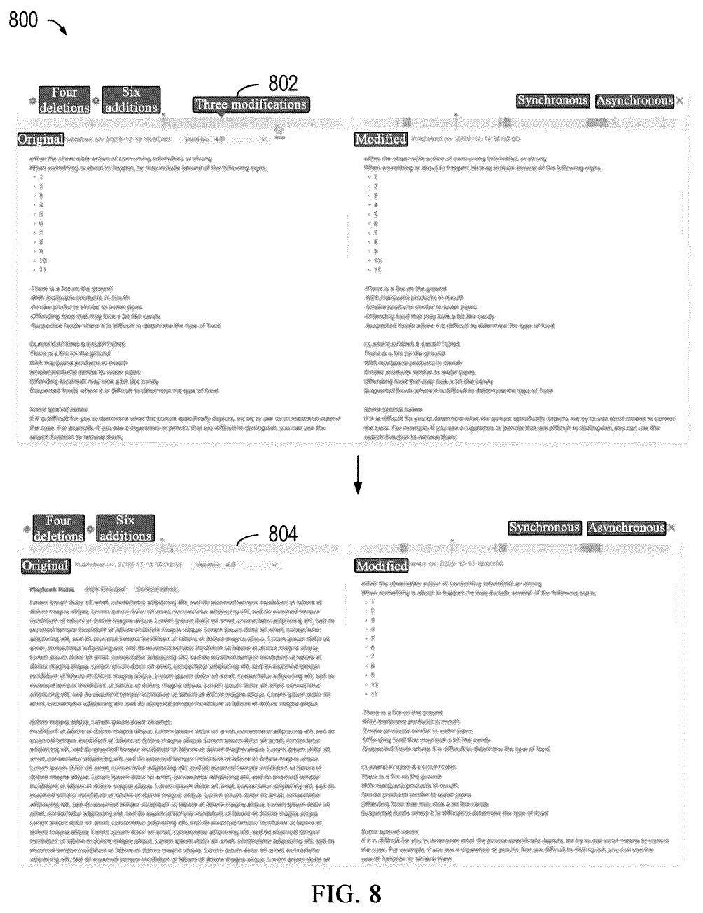

The schematic diagram of an example for partitioning of the navigation bar of the text according to some embodiments of the present disclosure has been described above with reference to FIG. 7. Next, a schematic diagram of an example for displaying the number of modifications on the navigation bar sub-region of the text according to some embodiments of the present disclosure is to be depicted below with reference to FIG. 8.

In the example 800, with reference to the above example 700, in response to receiving that the cursor hovers over a sub-region 804 of the navigation bar of the original text or the hovering reaches or exceeds a first predetermined duration, e.g., one second, the computing device displays a prompt information 802 with respect to the number of modifications of this sub-region. For example, the prompt information indicates “three modifications”.

In some embodiments, in response to receiving that the prompt information has appeared for or beyond a second predetermined duration, e.g., five seconds, the computing device hides the prompt information 802.

In some embodiments, when detecting that the cursor is within the sub-region, the computing device always shows the prompt information 802 regarding the number of modifications in the sub-region until it is detected that the cursor leaves the sub-region. Then, the computing device hides the prompt information 802.

Moreover, after receiving an operation for clicking the sub-region by the cursor, the computing device scrolls the original text to a position where text modifications are made in the sub-region. Additionally, when the text content of the sub-region exceeds a display range, the original text is scrolled to a position where a first modification is made in the sub-region.

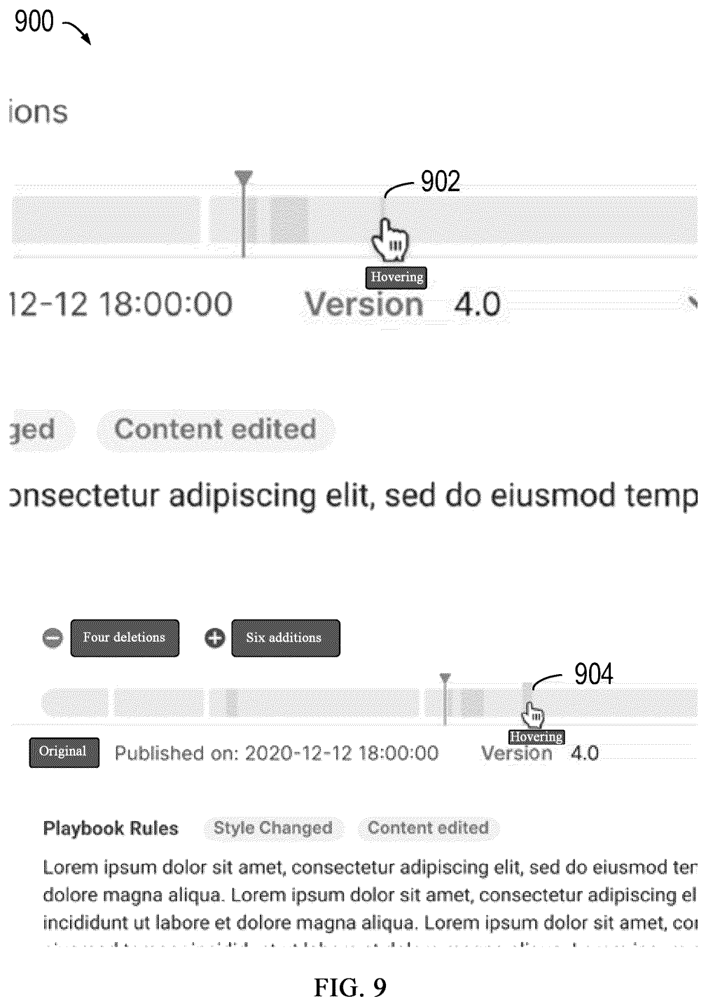

The schematic diagram of an example for displaying the number of modifications on the navigation bar sub-region of the text according to some embodiments of the present disclosure has been described above with reference to FIG. 8. Next, a schematic diagram of an example in which modification marks in the sub-region of the navigation bar are enlarged according to some embodiments of the present disclosure is to be depicted below with reference to FIG. 9.

In the example 900, with reference to the previous examples 700 and 800, the sub-region of the navigation bar includes a modification mark 902 for the text modification in the text.

In some embodiments, upon receiving that the cursor hovers over the modification mark or the hovering reaches or exceeds a predetermined duration, such as one second, the computing device displays the modification mark 902 in bold as modification mark 904. In addition, when the modification mark 902 is displayed in bold as modification mark 904, the modification mark is kept in the state of the modification mark 904 until the cursor moves outside of the display range of the bolded modification mark 904. Then, the modification mark returns to the original modification mark 902.

In some embodiments, upon receiving an operation for clicking the modification mark 904 by the cursor, the computing device scrolls the original text to a portion corresponding to the modification mark 904.

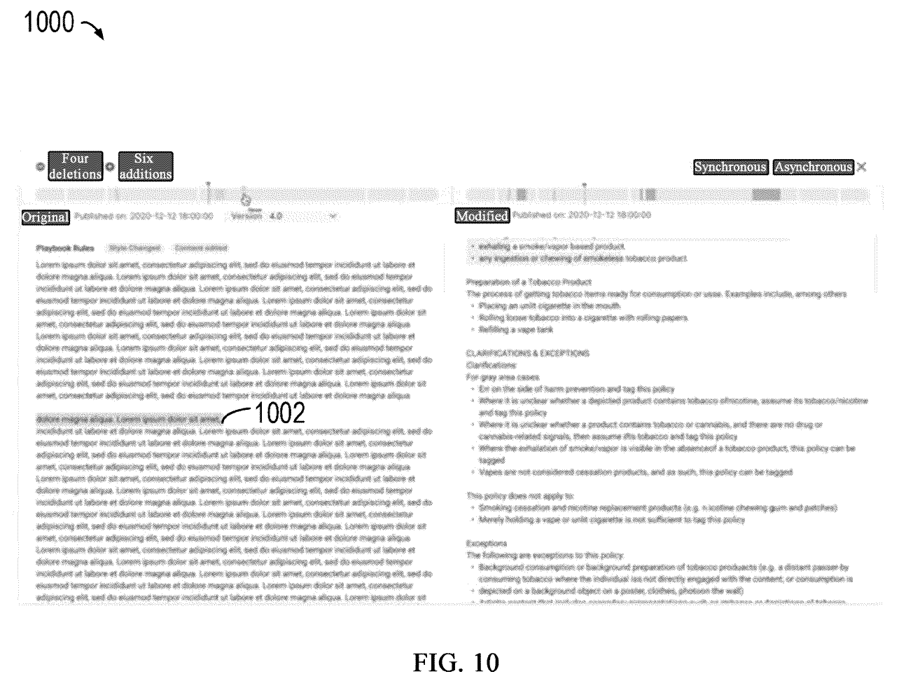

The schematic diagram of an example in which modification marks in the sub-region of the navigation bar are enlarged according to some embodiments of the present disclosure has been described above with reference to FIG. 9. Next, a schematic diagram of an embodiment for automatically jumping to the modification position of text alignment according to some embodiments of the present disclosure is to be depicted below with reference to FIG. 10.

In the example 1000, with reference to the above examples 700-900, after receiving an operation for clicking the modification mark 904 by the cursor, the computing device scrolls the original text to a content corresponding to the modification mark 904.

In some embodiments, when the original text automatically jumps to the portion corresponding to the modification mark or the modified text, the modified text 1002 is placed in the middle of the original text and highlighted. Additionally, after the original text automatically jumps to a sub-region corresponding to the modification mark, the modified text 1002 is placed at the first line of the original text and highlighted.

In some embodiments, after the original text automatically jumps, the computing device would detect the context of this text modification. If the modified text has the same context of this text modification, the modified text automatically scrolls and jumps, such that the modified text and the original text are in the same position, to facilitate comparison.

For example, when the modified text has the same text as the text of the previous paragraph of a text modification 1002 of the original text, the modified text scrolls and jumps to align the text of the paragraph of the modified text with the text of the paragraph of the original text.

In some embodiments, if the modified text does not have the same context as the text modification, only the original text automatically jumps and no operation is made to the modified text. Additionally, in such case, the modified text may automatically jump to the first line of the sub-region corresponding to the text modification 1002.

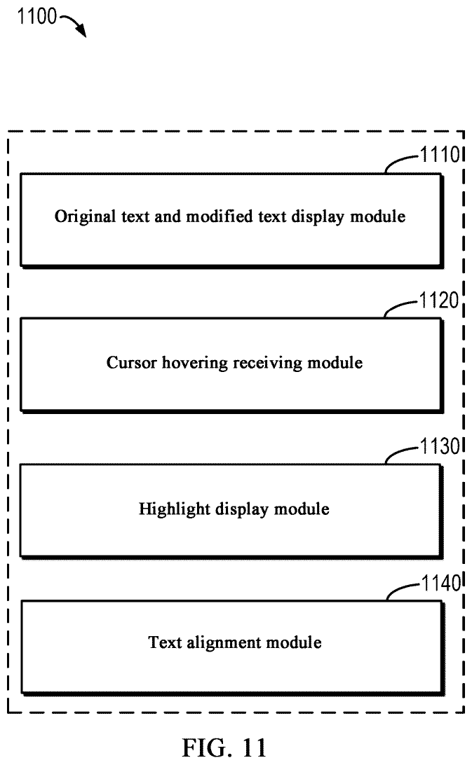

As shown in FIG. 11, the apparatus 1100 comprises an original text and modified text display module 1110 configured to display an original text and a modified text of the original text: a cursor hovering receiving module 1120 configured to receive hovering of a cursor over a first line in one text of the original text or the modified text: a highlight display module 1130 configured to highlight the first line and a second line in the other text of the original text or the modified text corresponding to the first line based on the hovering of the cursor over the first line; and a text alignment module 1140 configured to, in response to receiving an operation for clicking associated with the hovering cursor, align the first line with the second line to implement text alignment.

In some embodiments, the highlight display module 1130 also includes: a duration determining module configured to determine a duration of the cursor hovering over the first line; a second line determining module configured to, in response to the duration exceeding a predetermined duration, determine the second line corresponding to the first line in the other text; and the highlight display module is configured to highlight the first line and the second line.

In some embodiments, the highlight display module also includes: a connecting line display module configured to display a connecting line for connecting the first line with the second line; and a prompt information display module configured to display a prompt information for an alignment operation.

In some embodiments, the connecting line is positioned in a gap between the original text and the modified text.

In some embodiments, the text alignment module 1140 also includes: another text scroll module configured to, in response to receiving an operation for clicking associated with the hovering cursor, scroll the other text; and a text alignment module configured to, in response to the second line in the other text being at the same horizontal position as the first line, stop the scroll to align the second line with the first line.

In some embodiments, the apparatus 1100 also comprises: a synchronous scroll control and asynchronous scroll control display module configured to display a synchronous scroll control and an asynchronous scroll control for a scroll operation: a first scroll operation receiving module configured to, in response to the synchronous scroll control being selected, receive a first scroll operation for the original text or the modified text; and a synchronous scroll module configured to synchronously scroll the original text and the modified text based on the first scroll operation.

In some embodiments, the apparatus 1100 also comprises: a second scroll operation receiving module configured to, in response to the asynchronous scroll control being selected, receive a second scroll operation for the original text or the modified text; and a scroll module configured to scroll the original text or the modified text based on the second scroll operation.

In some embodiments, the apparatus 1100 also comprises: an addition portion and deletion portion determining module configured to determine an added portion and a deleted portion based on the original text and the modified text: the highlight display module is configured to highlight the added portion in the modified text and highlight the deleted portion in the original text.

In some embodiments, the apparatus 1100 also comprises: a sub-region number determining module configured to determine the number of a set of sub-regions in a navigation bar associated with the one text based on the number of a set of paragraphs in the one text: a second length determining module configured to determine a second length of a first sub-region in a set of sub-regions corresponding to the paragraph based on a first length of a paragraph in the set of paragraphs; and a navigation bar display module configured to display the navigation bar based on the number of the set of sub-regions and the second length.

In some embodiments, the apparatus 1100 also comprises: a hover receiving module configured to receive hovering of the cursor over a second sub-region in the set of sub-regions; and a modification number display module configured to display the number of a set of modifications in a paragraph in the set of paragraphs corresponding to the second sub-region based on the hovering of the cursor over the second sub-region.

In some embodiments, the second sub-region includes a set of modification marks corresponding to the set of modifications. Besides, the apparatus 1100 also comprises: a hover receiving module configured to receive hovering of the cursor over a target modification mark in the set of modification marks: an enlargement module configured to enlarge the target modification mark: a jumping module configured to, in response to receiving an operation for clicking the target modification mark enlarged, jump to a modification portion corresponding to the target modification mark in the one text; and a module for highlighting the modification for a predetermined duration configured to highlight the modification portion for a predetermined duration.

In some embodiments, the apparatus 1100 also comprises: a navigation bar display module configured to display the navigation bar at one of following positions: above, below, to the left or to the right of the one text.

In some embodiments, the apparatus 1100 also comprises: an original text display module configured to display the original text in one column of a left column and a right column; and a modified text display module configured to display the modified text in the another column of the left column and the right column.

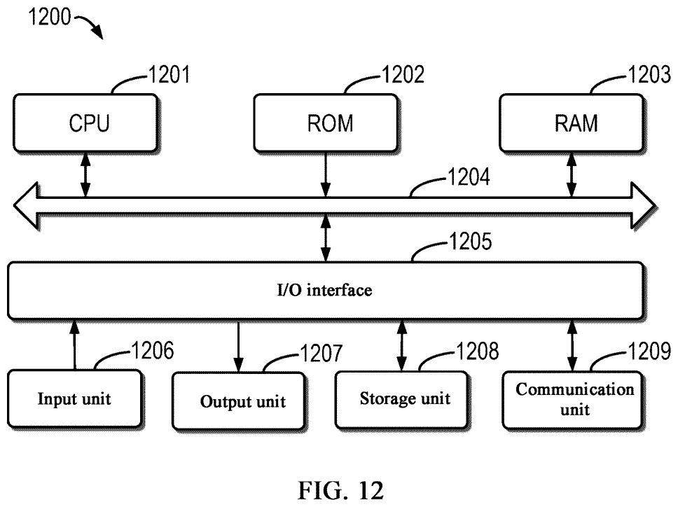

FIG. 12 illustrates a schematic block diagram of an example device 1200 for implementing embodiments of the present disclosure. The computing device 104 in FIG. 1 may be implemented by the device 1200. As shown in FIG. 12, the device 1200 comprises a central process unit (CPU) 1201, which can execute various suitable actions and processing based on the computer program instructions stored in the read-only memory (ROM) 1202 or computer program instructions loaded in the random-access memory (RAM) 1203 from the storage unit 1208. The RAM 1203 can also store all kinds of programs and data required by the operation for the device 1200. CPU 1201. ROM 1202 and RAM 1203 are connected to each other via a bus 1204. The input/output (I/O) interface 1205 is also connected to the bus 1204.

A plurality of components in the device 1200 is connected to the I/O interface 1205, including: an input unit 1206, such as keyboard, mouse and the like: an output unit 1207, e.g., various kinds of display and loudspeakers etc.; a storage unit 1208, such as disk and optical disk etc.; and a communication unit 1209, such as network card, modem, wireless transceiver and the like. The communication unit 1209 allows the device 1200 to exchange information/data with other devices via the computer network, such as Internet. and/or various telecommunication networks.

The above described procedure and processing, such as method 200, can be executed by the processing unit 1201. For example, in some embodiments, method 200 can be implemented as a computer software program tangibly included in the machine-readable medium, e.g., storage unit 1208. In some embodiments, the computer program can be partially or fully loaded and/or mounted to the apparatus 1200 via ROM 1202 and/or communication unit 1209. When the computer program is loaded to RAM 1203 and executed by the CPU 1201, one or more actions of the above described method 200 can be implemented.

The present disclosure can be method, apparatus, system and/or computer program product. The computer program product can include a computer-readable storage medium, on which the computer-readable program instructions for executing various aspects of the present disclosure are loaded.

The computer-readable storage medium can be a tangible apparatus that maintains and stores instructions utilized by the instruction executing apparatuses. The computer-readable storage medium can be, but not limited to, such as electrical storage device, magnetic storage device, optical storage device, electromagnetic storage device, semiconductor storage device or any appropriate combinations of the above. More concrete examples of the computer-readable storage medium (non-exhaustive list) include: portable computer disk, hard disk, random-access memory (RAM), read-only memory (ROM), erasable programmable read-only memory (EPROM or flash), static random-access memory (SRAM), portable compact disk read-only memory (CD-ROM), digital versatile disk (DVD), memory stick, floppy disk, mechanical coding devices, punched card stored with instructions thereon, or a projection in a slot, and any appropriate combinations of the above. The computer-readable storage medium utilized here is not interpreted as transient signals per se, such as radio waves or freely propagated electromagnetic waves, electromagnetic waves propagated via waveguide or other transmission media (such as optical pulses via fiber-optic cables), or electric signals propagated via electric wires.

The described computer-readable program instruction can be downloaded from the computer-readable storage medium to each computing/processing device, or to an external computer or external storage via Internet, local area network, wide area network and/or wireless network. The network can comprise copper-transmitted cable, optical fiber transmission, wireless transmission, router, firewall, switch, network gate computer and/or edge server. The network adapter card or network interface in each computing/processing device receives computer-readable program instructions from the network and forwards the computer-readable program instructions for storage in the computer-readable storage medium of each computing/processing device.

The computer program instructions for executing operations of the present disclosure can be assembly instructions, instructions of instruction set architecture (ISA), machine instructions, machine-related instructions, microcodes, firmware instructions, state setting data, or source codes or target codes written in any combinations of one or more programming languages, wherein the programming languages comprise object-oriented programming languages, e.g., Smalltalk, C++ and so on, and traditional procedural programming languages, such as “C” language or similar programming languages. The computer-readable program instructions can be implemented fully on the user computer, partially on the user computer, as an independent software package, partially on the user computer and partially on the remote computer, or completely on the remote computer or server. In the case where remote computer is involved, the remote computer can be connected to the user computer via any type of networks, including local area network (LAN) and wide area network (WAN), or to the external computer (e.g., connected via Internet using the Internet service provider). In some embodiments, state information of the computer-readable program instructions is used to customize an electronic circuit, e.g., programmable logic circuit, field programmable gate array (FPGA) or programmable logic array (PLA). The electronic circuit can execute computer-readable program instructions to implement various aspects of the present disclosure.

Various aspects of the present disclosure are described here with reference to flow chart and/or block diagram of method, apparatus (system) and computer program products according to embodiments of the present disclosure. It should be understood that each block of the flow chart and/or block diagram and the combination of various blocks in the flow chart and/or block diagram can be implemented by computer-readable program instructions.

The computer-readable program instructions can be provided to the processing unit of general-purpose computer, dedicated computer or other programmable data processing apparatuses to manufacture a machine, such that the instructions that, when executed by the processing unit of the computer or other programmable data processing apparatuses, generate an apparatus for implementing functions/actions stipulated in one or more blocks in the flow chart and/or block diagram. The computer-readable program instructions can also be stored in the computer-readable storage medium and cause the computer, programmable data processing apparatus and/or other devices to work in a particular manner, such that the computer-readable medium stored with instructions comprises an article of manufacture, including instructions for implementing various aspects of the functions/actions stipulated in one or more blocks of the flow chart and/or block diagram.

The computer-readable program instructions can also be loaded into computer, other programmable data processing apparatuses or other devices, so as to execute a series of operation steps on the computer, other programmable data processing apparatuses or other devices to generate a computer-implemented procedure. Therefore, the instructions executed on the computer, other programmable data processing apparatuses or other devices implement functions/actions stipulated in one or more blocks of the flow chart and/or block diagram.

The flow chart and block diagram in the drawings illustrate system architecture, functions and operations that may be implemented by system, method and computer program product according to multiple implementations of the present disclosure. In this regard, each block in the flow chart or block diagram can represent a module, a part of program segment or code, wherein the module and the part of program segment or code include one or more executable instructions for performing stipulated logic functions. In some alternative implementations, it should be noted that the functions indicated in the block can also take place in an order different from the one indicated in the drawings. For example, two successive blocks can be in fact executed in parallel or sometimes in a reverse order dependent on the involved functions. It should also be noted that each block in the block diagram and/or flow chart and combinations of the blocks in the block diagram and/or flow chart can be implemented by a hardware-based system exclusive for executing stipulated functions or actions, or by a combination of dedicated hardware and computer instructions.

Various embodiments of the present disclosure have been described above and the above description is only exemplary rather than exhaustive and is not limited to the embodiments of the present disclosure. Many modifications and alterations, without deviating from the scope and spirit of the explained various embodiments, are obvious for those skilled in the art. The selection of terms in the text aims to best explain principles and actual applications of each embodiment and technical improvements made in the market by each embodiment, or enable those ordinary skilled in the art to understand embodiments of the present disclosure.

I/We claim:

1. A method for aligning texts, comprising:
displaying an original text and a modified text for the original text:
receiving hovering of a cursor over a first line in one text of the original text or the modified text:
highlighting the first line and a second line in the other text of the original text or the modified text corresponding to the first line based on the hovering of the cursor over the first line; and
in response to receiving an operation for clicking associated with the hovering cursor, aligning the first line with the second line to implement text alignment.

2. The method of claim 1, wherein highlighting the first line and a second line in the other text of the original text or the modified text corresponding to the first line comprises:
determining a duration of the cursor hovering over the first line;
in response to the duration exceeding a predetermined duration, determining the second line corresponding to the first line in the other text; and
highlighting the first line and the second line.

3. The method of claim 2, wherein highlighting the first line and a second line in the other text of the original text or the modified text corresponding to the first line further comprises:
displaying a connecting line for connecting the first line with the second line; or
displaying a prompt information for an alignment operation.

4. The method of claim 3, wherein the connecting line is positioned in a gap between the original text and the modified text.

5. The method of claim 1, wherein aligning the first line with the second line to implement text alignment comprises:
in response to receiving the operation for clicking associated with the hovering cursor, scrolling the other text; and
in response to the second line in the other text being at the same horizontal position as the first line, stopping the scrolling to align the second line with the first line.

6. The method of claim 1, further comprising:
displaying a synchronous scroll control and an asynchronous scroll control for a scroll operation:
in response to the synchronous scroll control being selected, receiving a first scroll operation for the original text or the modified text; and
synchronously scrolling the original text and the modified text based on the first scroll operation.

7. The method of claim 6, further comprising:
in response to the asynchronous scroll control being selected, receiving a second scroll operation for the original text or the modified text; and
scrolling the original text or the modified text based on the second scroll operation.

8. The method of claim 1, further comprising:
determining an added portion and a deleted portion based on the original text and the modified text:
highlighting the added portion in the modified text; and
highlighting the deleted portion in the original text.

9. The method of claim 1, further comprising:
determining a number of a set of sub-regions in a navigation bar associated with the one text based on a number of a set of paragraphs in the one text:
determining a second length of a first sub-region in a set of sub-regions corresponding to the paragraph based on a first length of a paragraph in the set of paragraphs; and
displaying the navigation bar based on the number of the set of sub-regions and the second length.

10. The method of claim 9, further comprising:
receiving hovering of the cursor over a second sub-region in the set of sub-regions; and
displaying a number of a set of modifications in a paragraph in the set of paragraphs corresponding to the second sub-region based on the hovering of the cursor over the second sub-region.

11. The method of claim 10, wherein the second sub-region comprises a set of modification marks corresponding to the set of modifications; and the method further comprises:
receiving hovering of the cursor over a target modification mark in the set of modification marks:
enlarging the target modification mark;
in response to receiving an operation for clicking the enlarged target modification mark, jumping to a modification portion in the one text corresponding to the target modification mark; and
highlighting the modification portion for a predetermined duration.

12. The method of claim 11, further comprising:
displaying the navigation bar at one of following positions: above, below, to the left or to the right of the one text.

13. The method of claim 11, further comprising:
displaying the original text in one column of a left column and a right column; and
displaying the modified text in the other column of the left column and the right column.

14. An electronic device, comprising:
at least one processor; and
a memory for storing instructions which, when executed by the at least one processor, causes the at least one processor to:
display an original text and a modified text for the original text:
receive hovering of a cursor over a first line in one text of the original text or the modified text:
highlight the first line and a second line in the other text of the original text or the modified text corresponding to the first line based on the hovering of the cursor over the first line; and
in response to receiving an operation for clicking associated with the hovering cursor, align the first line with the second line to implement text alignment.

15. The device of claim 14, wherein instructions causing the processor to highlight the first line and a second line in the other text of the original text or the modified text corresponding to the first line comprises instructions causing the processor to:
determine a duration of the cursor hovering over the first line;
in response to the duration exceeding a predetermined duration, determine the second line corresponding to the first line in the other text; and
highlight the first line and the second line.

16. The device of claim 15, wherein instructions causing the processor to highlight the first line and a second line in the other text of the original text or the modified text corresponding to the first line further comprises instructions causing the processor to:
display a connecting line for connecting the first line with the second line: or
display a prompt information for an alignment operation.

17. The device of claim 16, wherein the connecting line is positioned in a gap between the original text and the modified text.

18. The device of claim 14, wherein instructions causing the processor to align the first line with the second line to implement text alignment comprises instructions causing the processor to:
in response to receiving the operation for clicking associated with the hovering cursor, scroll the other text; and
in response to the second line in the other text being at the same horizontal position as the first line, stop the scrolling to align the second line with the first line.

19. The device of claim 14, the processor is further caused to:
display a synchronous scroll control and an asynchronous scroll control for a scroll operation:
in response to the synchronous scroll control being selected, receive a first scroll operation for the original text or the modified text; and
synchronously scroll the original text and the modified text based on the first scroll operation.

20. A non-transitory computer-readable storage medium with computer programs stored thereon which, when executed by a processor, causing the processor to:
display an original text and a modified text for the original text:
receive hovering of a cursor over a first line in one text of the original text or the modified text:
highlight the first line and a second line in the other text of the original text or the modified text corresponding to the first line based on the hovering of the cursor over the first line; and
in response to receiving an operation for clicking associated with the hovering cursor, align the first line with the second line to implement text alignment.
